(19) United States
(12) Patent Application Publication
(10) Pub. No.: US 2011/0207109 A1
(43) Pub. Date: Aug. 25, 2011

(54) METHOD FOR TESTING THE ACCURACY OF ANSWERS TO QUIZ QUESTIONS BY MEANS OF A QUIZ COMPUTER

(75) Inventor: Andreas Unsicker, Regensburg (DE)

(73) Assignee: Umediaentertainment GMBH, Regensburg (DE)

(21) Appl. No.: 12/089,808

(22) PCT Filed: Sep. 7, 2006
(86) PCT No.: PCT/DE2006/001602

§ 371 Date: Mar. 15, 2011

(30) Foreign Application Priority Data
Oct. 12, 2005 (DE) 10 2005 049 324.6

(51) Int. Cl. G09B 7/00

(52) U.S. Cl. 434/353

(57) ABSTRACT

The invention relates to a method for testing the accuracy of answers to quiz questions, wherein a quiz master and a participant use, respectively, an identical quiz computer, wherein an answer code sequence is subsequently compared by means of a solution code sequence when a button on the quiz computer of the participant is actuated, and the correct and incorrect answers of the participant, associated with the question, are displayed on the display either successively or simultaneously as “correct” or “incorrect”.

### FIELD OF THE INVENTION

The invention relates to a method for testing the accuracy of answers to quiz questions, wherein a quiz master and a participant use, respectively, an identical quiz computer, wherein upon questions asked by the quiz master the participant enters his answers as an answer code sequence into his quiz computer, wherein the quiz master enters an answer code sequence to the questions, which answer codes correspond to correct answers, wherein from the answer code sequence a solution code is calculated according to a given algorithm in the quiz computer of the quiz master by transformation by means of an unambiguous and reversible trans-formation algorithm, wherein the solution code is communicated to the participant, and the participant enters the solution code into the quiz computer, wherein in the quiz computer of the participant the answer code sequence for correct answers is calculated by reverse transformation by means of the same transformation algorithm and is compared to the entered answer code sequence, wherein the number of correctly entered answer codes calculated in this comparison of both sequences is determined and displayed on a display. The invention further relates to a variant of such a method and to a quiz computer with an operating program, which codes for one or several of these methods.

### PRIOR ART AND BACKGROUND OF THE INVENTION

From the document WO 02/031797, a quiz computer is known in the art, the operating program of which codes for a method of the above species. In the insofar known method, a communication takes place between a participant and a quiz master, and the quiz master offers a prize. Typically, the quiz master is an actor in a mass medium, for instance television. In the insofar known method, on the one hand filter functions are activated preventing that participants not having correctly answered all questions will call the quiz master. Only for those participants having correctly answered all questions, a telephone number for calling is displayed on the display. Furthermore, various security features are provided preventing that cheats rightlessly claim the prize.

A similar quiz computer is known from the granted patent DE 198 19 920.

It is disadvantageous, in the insofar known quiz computers, that a participant receives information about the number of correct answers, however not about which answers were correct and which were incorrect, and in the latter case, what would have been the correct answer. For this, not only the cooperation of the quiz master is required, but rather a participant must either have written down his entries or memorized them. Otherwise, verification by the participant is not at all possible. This is inconvenient and time-consuming. Therefore, it would be desirable to provide a quiz computer with a function, by means of which correct and incorrect answers can be identified at the end of the quiz or after each entry of an answer, and if applicable, the correct answers additionally are displayed.

Furthermore, the security requirements against cheats are comparatively lower for quiz games with low prizes or none at all, however security functions are nevertheless required even for games without prize offering, since even for these games cheating must be excluded. Therefore, it is desirable to provide a quiz computer, the operating program of which codes for a method for testing the accuracy of answers to quiz questions, allowing simple, yet reliable checks by a quiz master.

### TECHNICAL OBJECT OF THE INVENTION

It is therefore the technical object of the invention to provide a method for testing the accuracy of answers to quiz questions, which comprises means for displaying correct and incorrect answers.

It is therefore further the technical object of the invention to provide a method for testing the accuracy of answers to quiz questions, which comprises a simple and reliable monitoring function.

### BASICS OF THE INVENTION AND PREFERRED EMBODIMENTS

For achieving this technical object, the invention teaches a method for testing the accuracy of answers to quiz questions, wherein a quiz master and a participant use, respectively, an identical quiz computer, wherein upon questions asked by the quiz master the participant enters his answers as an answer code sequence into his quiz computer, wherein the quiz master enters at an arbitrary point in time an answer code sequence to the questions, which answer codes correspond to correct answers, wherein from the answer code sequence a solution code is calculated according to a given algorithm in the quiz computer of the quiz master by transformation by means of an unambiguous and reversible transformation algorithm, wherein after answering the last question by the participant, the solution code is communicated to the participant, and the participant enters the solution code into the quiz computer, wherein in the quiz computer of the participant the answer code sequence for correct answers is calculated by reverse transformation by means of the same trans-formation algorithm and is compared to the entered answer code sequence, wherein the number of correctly entered answer codes calculated in this comparison of both sequences is determined and displayed on a display, and wherein when a button on the quiz computer of the participant is actuated, a comparison of both sequences is subsequently made and the correct and incorrect answers of the participant, associated with the questions, are displayed on the display either successively or simultaneously as “correct” or “incorrect”. In this variant, the communication of the solution code is only made after the entry of last answer of the quiz.

In an alternative variant, in which the solution code is entered before the entry of the first answer, the invention teaches a method for testing the accuracy of answers to quiz questions, wherein a quiz master and a participant use, respectively, an identical quiz computer, wherein upon questions asked by the quiz master the participant enters his answers as an answer code sequence into his quiz computer, wherein the quiz master enters before the beginning of the quiz an answer code sequence to the questions, which answer codes correspond to correct answers, wherein in the quiz computer of the quiz master, wherein from the answer code sequence a solution code is calculated according to a given algorithm in the quiz computer of the quiz master by transformation by means of an unambiguous and reversible transformation algorithm, wherein before the beginning of the quiz, the solution code is communicated to the participant, and the participant enters the solution code into the quiz computer, wherein in the quiz computer of the participant the answer code sequence for correct answers is calculated by reverse transformation by means of the same transformation algorithm and is compared to the entered answer code sequence, wherein with each entered answer code a comparison is subsequently made and every correct or incorrect answer of the participant is displayed on the display as “correct” or “incorrect” immediately after the entry of the respective answer code, and wherein optionally after entry of all answer codes into the quiz computer of the participant the number of correctly entered answer codes calculated in the comparison of both sequences is determined and displayed on a display.

By the invention, it is achieved that a participant obtains in every case information about the correctness or incorrectness of every single one of his entered answers and not only information about the total number of correct answers without assignment to the correctly answered questions.

In an embodiment of independent significance, the solution code entered by the participant is displayed after actuation of a check button. The quiz master can then compare the displayed solution code with the communicated solution code and unmask a potential cheat, who for instance knows a sequence of correct answer codes with the respective solution from a previous quiz and has entered it, since then all questions are displayed as correctly answered, however the displayed solution code differs from the correct solution code for the present quiz. Of course, for subsequent quiz events, the solution codes for correct answers can be chosen so that they differ in the sequence from corresponding previous quiz events.

In particular, every answer code may be a single-digit character, in particular a number, different answers to a question being assigned to different characters. Preferably, the number of possible answer codes for a single question is smaller than 10, in particular 2 to 9, preferably to 5 or 2 to 4, wherein the characters of the answer codes are lined up to an answer code series, wherein the answer code series is subdivided into partial series, in particular each comprising 2 or 3 answer codes, wherein a different solution code character is assigned to each different partial series, wherein the solution code is formed from the series of solution code characters obtained thereby, wherein the number of the characters of the solution code is smaller than the number of the answer codes. Hereby, so to speak a data reduction is achieved by reduction of the number of the character elements in the solution code compared to the number of the answer codes. This is useful, since in a quiz with a high number of questions the solution code would otherwise be correspondingly long, with the consequence of a time-consuming entry and the risk of faulty entries by a participant.

For the purpose of the comparison of an answer code sequence entered by a participant with an answer code sequence of correct answers from the entered solution code, a series of solution code characters can be formed, wherein a partial series of an answer code is assigned to each solution code character, and wherein the partial series are lined up to an answer code sequence in the order of the solution code characters. This is basically the reverse process of the generation of a solution code from answer codes. In particular, the answer code sequence of correct answers and the answer code sequence entered by the participant are compared with each other for the first digit each, and in case of a match of the first digits a “correct” memory is increased from 0 by 1, wherein the comparison is repeated for the second digit and in case of a match of the second digits, the “correct” memory is increased by 1, etc., until all n digits have been compared with each other, wherein after termination of the comparison the content of the “correct” memory is shown on the display, optionally also showing n.

In a detailed description of the invention, the answer code sequence of correct answers can be compared with an answer code entered by the participant when an arrow button is actuated, wherein upon a first actuation a comparison of the first answer code with the first digit of the answer code sequence of correct answers is made and in case of a match a “correct” message and in case of a mismatch an “wrong” message, optionally additionally or only including the correct answer code, is displayed on the display, wherein the above step is repeated for every actuation such that upon the n^{th} actuation a comparison with the n^{th} digit of the correct answer code sequence is made. By a second arrow button, control can be returned to respective (n−1)^{th} digit, so that with both arrow buttons all n answers can be selected in an arbitrary manner.

Furthermore, the invention relates to a quiz computer comprising an entry keyboard and a display and a processor unit connected to the entry keyboard and the display, in the program memory of which an operating program coding for a method according to the invention is stored.

In the following, the invention is described in more detail with reference to embodiments representing examples of execution only.

### Example 1

### Quiz Computer According to the Invention

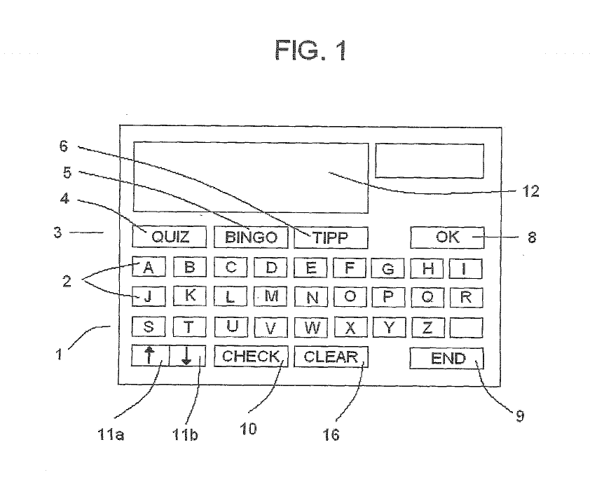

In FIG. 1, a quiz computer according to the invention is shown. The quiz computer comprises a letter keyboard 1 with one letter button 2 for each letter of the alphabet, optionally a game selection keyboard 3 with the buttons 4, 5, 6, and 7 for the selection of the desired game, an OK button 8, an end button 9, a check button 10, an off button 11, arrow buttons 11a and 11b, and a display 12. Further, a correction button 16 is provided. On the display 12, various statements can be shown, which are described in detail in the following examples.

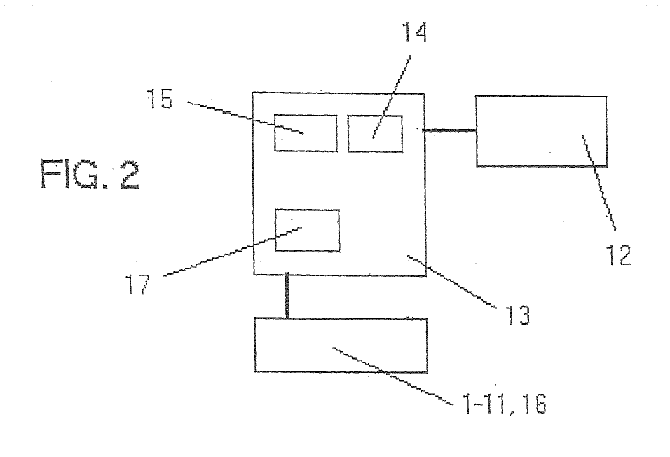

According to FIG. 2, the electronic circuitry comprises a computer unit 13 with an operating program stored in a read-only memory unit 14. The computer unit is connected with the buttons 1 to 11b and 16 and is controlled thereby. The display 12 is also connected with the computer unit 13 and shows information determined by means of the operating program and intended for outputting to a viewing person. Of course, instead of or in addition to the display 12, means for acoustic or other output of information may also be provided. The operating program activates the functions, as described in the following example. An operation memory 17 is used for intermediate storage of information in the usual way of a computer system.

### Example 2

### Quiz Function

This function can for instance be used for a multiple choice (mc) quiz. An mc quiz is a quiz, in which a player must enter a letter or a (single-digit) number as an answer to a question, and the letters or numbers are assigned by the organizer of the quiz to several answers offered for selection. It may be provided that only one answer is correct, but several correct answers to a question are also possible. Further, so-called order questions are possible, in which the answer has to be given in a defined order of letters or numbers, which are assigned to the order asked for (example: question: decreasing size of a ball? a: soccer ball, b: tennis ball, c: golf ball, d: volley ball; correct answer: adbc).

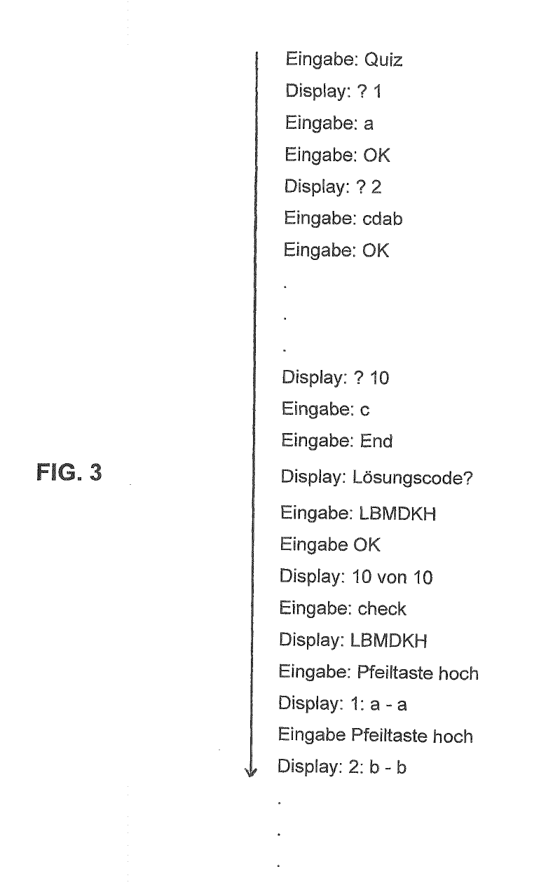

For the game function mc quiz, the following procedures are integrated in the operating program. These procedures are also explained in FIG. 3. The game is initialized by pressing the quiz button 4 and thereby the respective operating program section is activated.

After pressing the quiz button 4, a request for entry of the first answer to a question, which is for instance asked by the quiz master with defined answer alternatives or orders, appears on the display 12. On the display 12, a “1” may appear as a hint to the first question or answer, respectively. Then the participant enters the letter for the in his opinion correct answer (or a sequence of letters for the assumed correct order upon an order question). Entry of the answer is completed with an actuation of the OK button 8. Then appears a “2” with the request for entry of the second answer, etc. After the entry of the last answer, the quiz is completed with an actuation of the end button 9. Then, by means of the display 12, the entry of a solution code is requested.

The solution code is determined by the quiz master by means of the correct answers and is communicated after the end of the quiz. The solution code can for instance be generated as follows.

Assuming that 10 questions with an answer range from A to D (mc) are provided. The correct answers or the series of answer codes will then, in the order of the questions, for instance result in CDABDAADCC. If A=1, B=2, C=3 and D=4, then the sequence of numbers 34 12 41 33 will result. If the above groups of two are then trans-formed with the following matrix

11=A 12=B 13=C 14=D

21=E 22=F 23=G 24=H

31=I 32=J 33=K 34=L

41=M 42=N 43=O 44=P,

LBMDK is obtained as solution code. Of course, the above assignments, groups and the matrix elements can be varied in an arbitrary manner, and it is essential that the solution code has a smaller number of digits than the number of the entered answer codes, i.e. it is compressed. There is however always an unambiguous assignment that is reversible.

After the requests for the entry of the solution code, the participant must now wait for the communication of the solution code by the quiz master. The entry is then made, which is completed by the OK button 8. Then, by means of the above matrix also stored in the quiz computer, the sequence of numbers correlated with the solution code is determined therefrom, i.e. 3412411433. The computer unit of the quiz computer compares the result of these operations digit by digit with the sequence of numbers, which was obtained from the entered answers and determines by means of the matches the number of the correct answers. If from the entered answers 3412411433 results, then all answers are correct. If the sequence of numbers from the answers were however for instance 1412211431, then only 7 answers were correct. The number of the correct answers from the above evaluation is then displayed on the display 12.

If all answers entered by the participant are displayed as correct (in the example 10 of 10), the participant will communicate this to the quiz master. Then the quiz master asks the participant to actuate the check button, whereupon the solution code previously entered by the participant is displayed. The quiz master compares this displayed solution code with the solution code previously communicated by him. In case of a match, the participant is verified as playing correctly. If the participant had entered a series of answer codes and then a solution code known to him for instance from a previous quiz for the series of entered answer codes (instead of the solution code communicated by quiz master), then upon the actuation of the OK button “10 of 10” would be displayed, but the comparison of the read-out solution codes with the solution code communicated by the quiz master would show that the game was incorrect.

By the actuation of the arrow buttons, the participant can, in case of incorrect answers, identify them and furthermore have the correct answers displayed by display of the solution code entered for a question and the correct solution code. Every actuation of a first arrow button activates the display of said information to the (n+1)^{th} question. Vice versa, an actuation of the second arrow button activates the display of said information to the (n−¹)^{th} question (n=1, 2, . . . , number of questions, wherein by actuation of the arrow buttons 1 cannot be fallen below and the number of the questions cannot be exceeded).

Another variant of the quiz function can be that the participant has a limited time only for the entry of an answer. For this purpose, a device time is initialized with every entry of an answer code. The operation program is coded such that a participant has a limited time span only for answering a question. This can be visualized for the user by displaying remaining seconds on the display 12. After expiration, the answer to a subsequent question is requested, and that forcedly and without interference possibilities by a participant. No answer is detected by the operating program and regarded as incorrect, for instance by storing an answer code, which stands for no answer. No answer may however also be replaced in the operating program by a random answer, produced with a random generator (therefore most probably incorrect). Other substitution algorithms are also imaginable. After the last question, the participant is requested to enter the solution code in the way described above. In the quiz computer then proceed the previously described procedures.

Another variant can be that the solution code is entered before the entry of the first answer code. Then after every entry of an answer code, a display of the correct or incorrect answer may directly be provided, and reference is made to the general part of the specification.

1. A method for testing the accuracy of answers to quiz questions,
wherein a quiz master and a participant use, respectively, an identical quiz computer,
wherein upon questions asked by the quiz master the participant enters his answers as an answer code sequence into his quiz computer,
wherein the quiz master enters at an arbitrary point in time an answer code sequence to the questions, which answer codes correspond to correct answers,
wherein from the answer code sequence a solution code is calculated according to a given algorithm in the quiz computer of the quiz master by trans-formation by means of an unambiguous and reversible transformation algorithm,
wherein after answering the last question by the participant, the solution code is communicated to the participant, and the participant enters the solution code into the quiz computer,
wherein in the quiz computer of the participant the answer code sequence for correct answers is calculated by reverse transformation by means of the same transformation algorithm and is compared to the entered answer code sequence,
wherein the number of correctly entered answer codes calculated in this comparison of both sequences is optionally determined and displayed on a display, and
wherein when a button on the quiz computer of the participant is actuated, a comparison of both sequences is subsequently made and the correct and incorrect answers of the participant, associated with the questions, are displayed on the display either successively or simultaneously as “correct” or “incorrect”.

2. A method for testing the accuracy of answers to quiz questions,
wherein a quiz master and a participant use, respectively, an identical quiz computer,
wherein upon questions asked by the quiz master the participant enters his answers as an answer code sequence into his quiz computer,
wherein the quiz master enters before the beginning of the quiz an answer code sequence to the questions, which answer codes correspond to correct answers,
wherein from the answer code sequence a solution code is calculated according to a given algorithm in the quiz computer of the quiz master by trans-formation by means of an unambiguous and reversible transformation algorithm,
wherein before the beginning of the quiz, the solution code is communicated to the participant, and the participant enters the solution code into the quiz computer,
wherein in the quiz computer of the participant the answer code sequence for correct answers is calculated by reverse transformation by means of the same transformation algorithm and is compared to the entered answer code sequence, wherein in each entered answer code a comparison is subsequently made and every correct or incorrect answer of the participant is displayed on the display as “correct” or “incorrect” immediately after the entry of the respective answer code, and
wherein optionally after entry of all answer codes into the quiz computer of the participant the number of correctly entered answer codes calculated in the comparison of both sequences is determined and displayed on a display.

3. The method according to claim 1 or 2, wherein the solution code entered by the participant is displayed after actuation of a check button.

4. The method according to one of claims 1 to 3, wherein every answer code is a single-digit character, in particular a number, different answers to a question being assigned to different characters.

5. The method according to claim 4, wherein the number of possible answer codes for a single question is smaller than 10, in particular 2 to 9, preferably 2 to 5 or 2 to 4, wherein the characters of the answer codes are lined up to an answer code series, wherein the answer code series is subdivided into partial series, in particular each comprising 2 or 3 answer codes, wherein a different solution code character is assigned to each different partial series, wherein the solution code is formed from the series of solution code characters obtained thereby, wherein the number of the characters of the solution code is smaller than the number of the answer codes.

6. The method according to claim 5, wherein for the purpose of the comparison of an answer code sequence entered by a participant with an answer code sequence of correct answers from the entered solution code, a series of solution code characters is formed, wherein a partial series of an answer code is assigned to each solution code character, and wherein the partial series are lined up to an answer code sequence in the order of the solution code characters so as to form an answer code sequence.

7. The method according to claim 6, wherein the answer code sequence of correct answers and the answer code sequence entered by the participant are compared with each other for the first digit each, and in case of a match of the first digits a “correct” memory is increased from 0 by 1, wherein the comparison is repeated for the second digit and in case of a match of the second digits, the “correct” memory is increased by 1, etc., until all n digits have been compared with each other, wherein after termination of the comparison the content of the “correct” memory is shown on the display, optionally also showing n.

8. The method according to claim 6 or 7, wherein the answer code sequence of correct answers is compared with an answer code entered by the participant when the “check” button is actuated, wherein upon a first actuation a comparison of the first answer code with the first digit of the answer code sequence of correct answers is made and in case of a match a “correct” message and in case of a mismatch an “wrong” message, optionally additionally including the correct answer code, is displayed on the display, wherein the above step is repeated for every actuation such that upon the n^{th} actuation a comparison with the n^{th} digit of the correct answer code sequence is made.

9. A quiz computer comprising an entry keyboard and a display and a processor unit connected to the entry keyboard and the display, in the program memory of which an operating program coding for a method according to one of claims 1 to 8 is stored.
